(19) United States
(12) Patent Application Publication
(10) Pub. No.: US 2025/0033340 A1
(43) Pub. Date: Jan. 30, 2025

(54) Method for laminating a tufted good with a film to achieve tuft lock

(71) Applicant: John H. Bearden, Marietta, GA (US)

(72) Inventor: John H. Bearden, Marietta, GA (US)

(21) Appl. No.: 18/784,698

(22) Filed: Jul. 25, 2024

Related U.S. Application Data
(60) Provisional application No. 63/528,654, filed on Jul. 25, 2023.

(51) Int. Cl. B32B 37/04; B32B 3/08; B32B 27/06; B32B 27/32; E01C 13/08

(52) U.S. Cl. CPC B32B 37/04; B32B 3/085; B32B 27/06; B32B 27/32; B32B 2307/41; B32B 2307/748; B32B 2310/0843; B32B 2323/04; B32B 2323/10; E01C 13/08

(57) ABSTRACT

A method for laminating a tufted good made of a fabric backing sheet having a top face and a bottom face and having yarn tufted through the backing such that yarn pile extends from the top face and yarn backloops are along the bottom face. A polyethylene or polypropylene film sheet is placed against the backing bottom face, and laser energy is applied through the film sheet to soften the backing and film sheet at their interface and cause them to fuse and bind the yarn to the backing.

This non-provisional application claims the benefit of provisional application No. 63/528,654 filed Jul. 25, 2023.

### BACKGROUND OF THE INVENTION

Artificial turf is, primarily, made of a fabric backing substrate and filament yarns that imitate blades of grass. Often, these synthetic grass yarns are made of polyethylene, and the backing is constructed of multiple layers of woven (and, sometimes, non-woven) polypropylene. As part of the tufting process, the yarn is inserted into the backing as loops. Those loops are, then, severed to form cut pile along a top face of the backing sheet and backloops protruding from its opposing bottom face.

The inserted yarns, or “tufts”, must, then, be locked into place along the backing so that they are not easily dislodged by athletic use, in the case of artificial athletic turf, or simply due to normal wear and tear of non-athletic turf. This is achieved by applying coating material to the bottom face of the backing to enrobe the tuft backloops. Typically, the coating material used is a urethane applied in either of two forms: (a) as a liquid that requires that the coated backing be conveyed to within a heated oven environment for long enough for the urethane to cross-link into a solid, and then removed from the heat and allowed to cool and completely cure; or (b) as a two-part spray that is projected onto the backing surface and allowed to sit idle at room temperature long enough to self-cure. While urethane applied in either form can certainly be effective in achieving suitable tuft lock, it presents some notable inefficiencies in the turf manufacturing, installation, and removal processes.

To wit, as mentioned, during manufacture, curing an applied liquid-type urethane coating requires that the coated backing material pass through a heating oven. Therefore, relative to the spray version of urethane coating application, liquid application can necessitate significant capital expenditures associated with acquiring such an oven. Moreover, the size of both the oven and the production facility in which it is to be housed must correlate with the largest width dimension of coated backing material that a manufacturer wishes to be able to convey through the oven. This oven size consideration can be quite significant in the athletic turf manufacturing context, as segments of athletic turf that are to be installed side-by-side other such panels to form an athletic playing field are typically 15 feet wide. So, the oven must necessarily be wide enough to accommodate the width of the turf segments.

Not only does that coating oven-related facility space requirement represent a capital cost, it also represents ongoing energy costs and other operational costs associated with temperature controlling, illuminating, and otherwise maintaining that space. Chief among those costs is the cost of energy consumed in starting and continuing heat output by the oven. Moreover, since the oven is not a closed enclosure, significant heat loss occurs while it operates—which, in turn, necessitates more energy consumption in maintaining the oven temperature, and can have some bearing on energy consumption for maintaining comfortability of the indoor workspace.

From a facility space provisioning perspective, the spray coating method similarly warrants dedicating some amount of indoor space to that step of turf production so that it can be performed in an environment in which the ambient temperature and airflow are closely controllable, and in which air toxicity created by the urethane spray poses a minimal health risk to facility workers. Nevertheless, even under the most ideal air current conditions, it is virtually inevitable that some volume of sprayed particles will be wasted by depositing along surfaces other than that of the intended deposit surface of the tufted backing (e.g., onto the facility floor, walls, and other equipment). Furthermore, spray coating has significant energy consumption implications associated with operating pumps and heating the chemicals that are to be combined to form the spray mixture.

Then, regardless of which coating step was employed, after the coating is cured, discrete segments of tufted and coated backing are placed into rolls for shipping to their installation destination. The weight of those tufted goods is substantially attributed to the weight of their urethane coating element. So, there exists a direction correlation between (a) the cost of shipping athletic turf from manufacturing site to installation site and (b) the volume of urethane coating material used in producing it.

Finally, long after the manufacturing and installation processes are complete, installed athletic turf eventually becomes worn and needs to be replaced at the athletic site. Fortunately, since polyethylene and polypropylene are recyclable, the degraded turf's polyethylene grass fibers can be sheared from the backing to be recycled into newly usable tufting yarn. However, the fact of urethane being adhered to the backing of a turf product renders a polypropylene backing unrecyclable and merely discardable. So, urethane coating, in either form, thwarts what would, otherwise, be the gained efficiency of having produced a fully recyclable turf product. Over time, this represents a significant lost opportunity cost.

Consequently, the present inventor recognizes that there is a great need, in the artificial athletic turf industry, to supplant urethane, as a coating material, with a recyclable material capable of achieving equal or more tuft lock strength with equal or less material (by weight), and that can be applied within a smaller dedicated production space within a dramatically shorter production time and consuming dramatically less energy. The present inventor further recognizes that this panacea of a combination of advancements can be achieved using either a pre-perforated (for drainage purposes) or non-perforated polyethylene or polypropylene film, rather than liquid or sprayed urethane, as the coating material and by applying laser energy, rather than using a heat oven, to superficially melt and fuse together the film and tufted backing sheets. The present inventor also recognizes that there is a need to employ laser energy in a particular fashion and in combination with a substantially translucent polyethylene or polypropylene coating film that is placed against an opaque-surfaced backing sheet, because doing so is particularly useful in achieving these advancements without compromising the structural integrities of the coating film sheet or tufted backing sheet and, therefore, where a pre-perforated film sheet is used, without diminishing the porosity of the resultant, fully recyclable turf product. The present invention for a method for laminating a backing sheet substantially fulfills those needs.

### SUMMARY OF THE INVENTION

The present invention generally relates to methods for binding the tufted yarns to the backing substrates of tufted goods, and it is specifically directed to such a method that uses laser energy to apply heat to sheets of polyethylene or polypropylene film that serve as a laminating material for sufficiently bonding such yarns and backings. It is a first object of the present invention to utilize material for achieving tuft lock within tufted goods that renders the goods devoid of any adhesive, fully recyclable, and lighter in weight than their conventional counterparts. It is a second object of the present invention to employ a process for achieving that tuft lock which is considerably more time, space, and energy efficient than conventional coating processes for achieving the same.

In one aspect of the invention, a yarn-tufted, fabric backing sheet is held inverted (i.e., yard pile side down) in order that a sheet of polyethylene or polypropylene film (hereinafter, simply a “film sheet” or “film”) may be laid against the bottom face of the backing sheet—that is, placed against the side of the backing sheet on which back stitches (“backloops”) of yarn tufts are exposed. Prior to such placement of a film sheet, it is anticipated that the tufted backing sheet will be tensioned into taut condition. This can be accomplished by, for example, pinning near edges of the backing sheet to a pin conveyor assembly that would enable the film and backing sheet combination to be conveyed longitudinally past at least one laser mechanism stationed in [longitudinally] fixed position to operate upon the sheet combination. Alternatively, the backing sheet could be tensioned by clamping it to a static support structure so it may be operated upon by a longitudinally travelling laser mechanism(s). Yet another embodiment contemplates the film and backing sheet combination being conveyed longitudinally while a laser-emitting mechanism that is mounted on a dual axis traversing mechanism sweeps over the entirety of the film and backing to fuse them together. This configuration permits the area of energy projected by the laser to form a spot with dimensions smaller than the width of the turf, and it allows that energy spot to traverse across the sheet in coordination with turf conveyance such that laser energy is delivered substantially uniformly to every point along the interface of the film and backing.

In another aspect of the invention, the polyethylene or polypropylene film sheet selected for use may be chosen based upon certain of its characteristics, as well as the intended use application of the tufted good. For example, tufted goods that are to function as indoor carpets will have lower tuft lock requirements (i.e., the force typically required to pull and dislodge a tuft from the backing) than if they were to function as artificial athletic turf. So, an athletic turf may warrant use of a thicker film sheet than a carpet would. That greater thickness allows for even more depth of the film to be melted along its surface that interfaces with the backing without diminution of the film's porosity. Also, the translucency of the film sheet may be of interest since pigmentation within the film sheet impacts the rate at which heat will be absorbed throughout the thickness dimension of the film while laser energy is passing through it enroute to the backing. In some instances, it may be preferred that the film contains dyes or fillers which increase its opacity and cause heat to be absorbed at every layer of thickness of the film. In other instances, it may be desired that the laser energy be minimally absorbed during passage through a translucent film and, instead, be almost entirely absorbed by the dark-colored surface of the backing sheet so that a superficial layer of thickness of the film along the contact interface with the backing sheet is melted only by virtue of heat having been conductively transmitted from the contact surface of the backing back to the contact surface of the film.

In another aspect of the invention, during the application of laser energy to the film and backing sheets, a mechanism for urging those sheets into more intimate contact should be employed. This urging mechanism could be in the form of a suction device, a roller, an air blower, or a brush, and its purpose is two-fold: (1) to maximize the aggregate surface area of sustained contact between the film sheet and the tufted backing sheet; and (2) to flatten the loop profiles of the tuft backloops along the face of the backing sheet to, thereby, increase the surface areas of contact interface between backloop inner surfaces and that backing face. Increased surface area contact, between both (a) film sheet and backing sheet and (b) yarn backloops and backing sheet, increases the surface area of film-backing sheet fusion and, therefore, improves the overall tuft bond strength of the resultant fused product.

Maximizing the surface area of contact between the sheets is made more critical by the purposeful limiting of the amount of laser energy directed through the film to only that needed to liquify only the film-backing contact interface and not a greater measure of the adjacent thickness of either sheet. Under the present method, the ultimate objective is to laminate a tufted backing with a perforated film to produce satisfactory tuft lock without disturbing the integrity of the perforations. In other words, the aim is to heat and liquify merely the contact surfaces of the film and backing without more thoroughly heating either sheet to deformity beyond anything more than a superficial level.

In another aspect of the invention, relative to conventional methods of bonding coating materials to backing substrates of tufted goods—which include using ovens or heat rollers to conductively melt a thermoplastic coating material or to cure urethane coating or applying urethane coating material by way of spraying—this use of laser energy to laminate the backing with a polyethylene or polypropylene film represents considerable energy savings for at least two reasons. For one, laser energy will travel through a translucent such film sheet, arrive at and be absorbed by an opaque backing surface, and conduct back to the film sheet sufficient heat to melt its surface—all in an incredibly shorter amount of time than heat in an oven environment or applied by a heat roller would conduct through the thickness of the same film sheet to heat the backing to the same degree. For another, the time required for laser energy applied through the film to cause melting along the film and backing contact interface is far shorter than the time that the materials would have to immersed in an oven environment or be in contact with a heat roller to induce that melting along that interface.

Finally, in yet another aspect of the invention, using laser projecting optics and an oscillating sweeping motion enables a desired level of substantially uniform laser energy density to be delivered over a larger area of the film than would be delivered by a more collimated laser beam. This even further accelerates the laser fusing process by increasing the pace at which either: (a) a two-dimensionally movable laser emitting mechanism can be advanced over the entire body of a stationary tufted good; or (b) a conveyor-carried tufted good can be advanced relative to either a series of spaced apart, stationary, laser-emitting mechanisms or at least one tufted good-traversing laser emitter in order to appropriately deliver laser energy throughout the entire length and width of the tufted good (i.e., deliver equal energy density to every position within the rectangular area of the tufted good).

Other vital aspects of the invention are disclosed by the description, claims, and illustrations that follow.

### BRIEF DESCRIPTION OF THE DRAWINGS

FIG. 1 is a perspective view of the laser application step of the process of the present invention;

FIG. 2 is a cross-sectional elevational view of a tufted good of the present invention; and

FIG. 3 is a cross-sectional perspective view of a single tuft of a tufted good of the same.

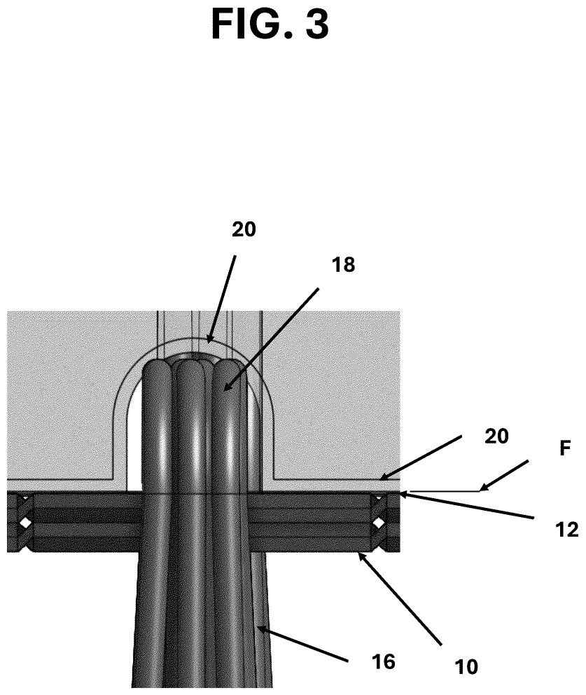

### DETAILED DESCRIPTION OF THE PREFERRED EMBODIMENTS

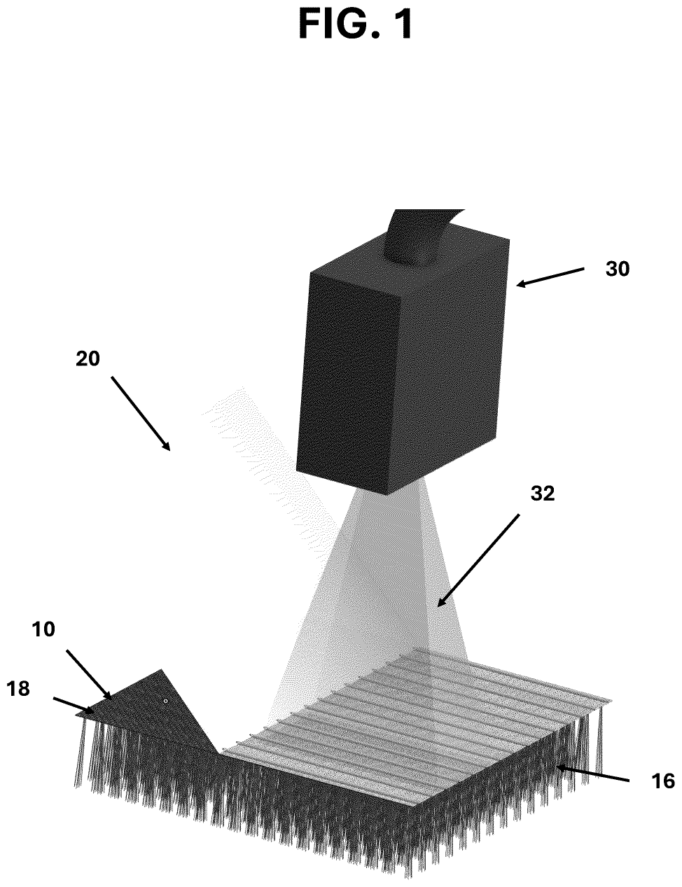

The present disclosure is especially applicable to creation of artificial athletic turf and, as such, artificial athletic turf is explicitly referenced hereinafter, but this disclosure can be applicable to creation of tufted goods generally (e.g., household carpet). With that understanding, some tangible aspects of this disclosure are embodied in all of the accompanying drawings, and they relate to a segment of turf product comprising the basic elements of: (1) fabric backing sheet 10; (2) a polyethylene (or polypropylene) film sheet 20; and (3) yarn tufted into the backing sheet 10 so as to form [cut] pile 16 along one side of and backloops 18 along the other side of the backing. A process step of this disclosure is embodied specifically in FIG. 1 which illustrates a laterally divergent, longitudinally oscillating laser beam 32 being projected towards the turf elements by a laser-emitting mechanism 30.

It should also be understood that some apparatus aspects of the disclosure are not reflected in the accompanying drawings. One such aspect concerns the various mechanisms that facilitate one or more laser emitters 30 being able to distribute laser energy throughout the entire length and width of a segment of turf elements. In a preferred embodiment of the present method, the backing 10 and film 20 are placed together onto a pin chain conveyor that advances and retracts them longitudinally, and a laser emitter 30 is stationed above them on a carriage that travels laterally along a gantry beam which, itself, advances and retracts longitudinally. The laser emitter 30 travels laterally along the gantry beam traversing more than the full width of the turf elements below it. As will be discussed further, in this embodiment, the turf elements are advanced by the conveyor in coordination with the sensor-driven lateral movements and outputting of the laser emitter. However, in other embodiments, the turf elements could be held in fixed position by clamping the perimeter of the backing 10 and film 20 to a support frame. In either case, it is also desirable that the film 20 resting atop the backing 10 be urged into more intimate contact with the backing 10 by operation of a vacuum device positioned below the backing 10.

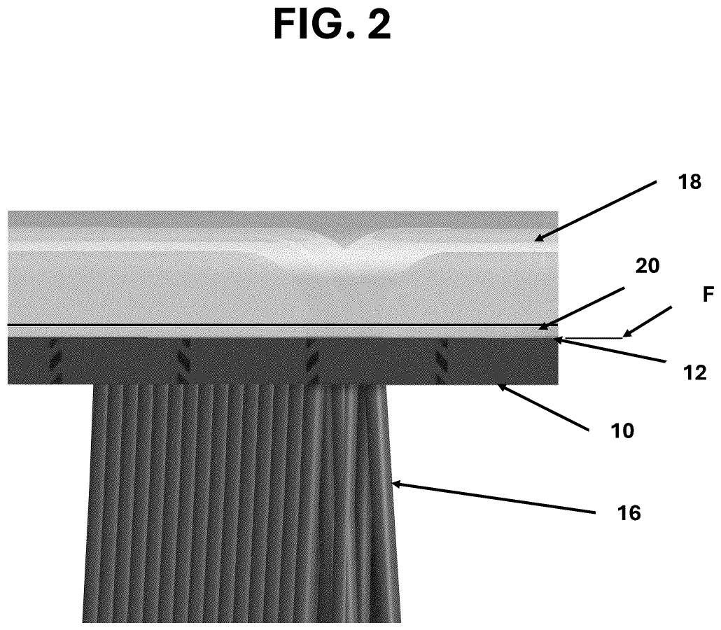

FIG. 1 illustrates a laser emitter projecting laser energy toward the polyethylene film sheet 20 laid atop the bottom face of the tufted backing sheet 10. The present inventor observes that producing the best results requires utilization of some form of laser projecting optics to gain laser beam optical control and limit the density of laser energy that will be absorbed at any point along the interface F of the film sheet 20 and backing sheet 10 that is most viewable in FIGS. 2 & 3. It is important to create a broader area of laser beam application having substantially uniform laser energy density than an unaltered laser beam of Gaussian distribution could realistically be anticipated to deliver.

Preferably, the laser emitter 30 performs oscillating longitudinal sweeps of a laterally diverging laser beam 32 at 60 Hz to create a three-dimensional beam profile that it projects into the film sheet 20. The laser wavelength and polyethylene film's opacity and thickness will dictate the amount of heat absorbed by the film from the incoming laser beam 32, but it is anticipated that all of those factors are controlled such that the laser energy passing through the film 20 is minimally absorbed by the film 20 and, instead, is substantially absorbed by the black-colored bottom surface 12 of the backing 10 to cause the temperature within an inner layer of the backing's contact surface 12 to rise to its melting point. In turn, because of the substantially continuous contact interface F between the film 20 and backing 10 (outside of the yarn backloop positions) and contact interface between the backloops 18 and backing 10 that is produced by the suction force, heat conducts from the warmed backing surface 12 to both the yarn backloops 18 and the film surface and causes the temperature within yarn and an inner layer of the film 20 to elevate to their respective melting points as well. This heating and melting occurs during the extremely short time period that the laser energy is being applied to the film 20, and the sheets 10, 20 and yarn backloops 18 fuse together thereafter. The delivery of laser energy provides nearly instantaneous material temperature elevation for achieving material fusion. This represents a dramatically quicker process than the time it would take to fuse the sheets 10, 20 (or the backing 10 and any other coating material) within an oven or by way of a spray coating process.

Moreover, sensors are used to control the lateral and longitudinal movement and the laser emission of the laser emitter 30 in coordination with longitudinal movement of the backing-film combination. More specifically, as the backing and film 10, 20 travel longitudinally, the laser beam 32, which has lateral and longitudinal dimensions upon arriving at the film sheet 20, is driven laterally across the gantry beam by its carriage while also being driven longitudinally by gantry movement in synchronization with the longitudinal backing and film movement. This distributes laser energy across a laterally-extending, rectangular swath of the film 20. Then, the sensors will cause the longitudinal gantry motion to cease whenever the tufted good's longitudinal advancement stops, but the laser emitter 30 will continue travelling laterally along the gantry to complete its then current lateral pass over the backing-film combination. A subsequent pass of laser energy along a longitudinally adjacent lateral segment of the film 20 is begun when the conveyor carrying the backing-film combination restarts and the sensor detects the next lateral pass position. It should also be understood that if the sensor detects any interruption or reversion in the backing-film combination's longitudinal advancement before the power emitter 30 completes a given lateral scan, the gantry's movement will mimic that action until that lateral scan is completed. This sensor-driven coordination of movement of the backing-film combination, movement of the gantry carrying the laser emitter 30, movement of the laser emitter 30 along the gantry, and operation of the laser emitter 30, in view of the profile of the emitted laser beam 32, is intended to ensure that an intended degree of laser energy density is distributed uniformly to every point along the film 20.

It is understood that substitutions and equivalents for various elements set forth above may be obvious to those skilled in the art and may not represent a departure from the spirit of the invention. Therefore, the full scope and definition of the present invention is

[symbol]

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A tufted good comprising:
a backing sheet having a pile face from which yarn piles project and an opposing bottom face, wherein the bottom face is defined by yarn backloops formed therealong and substantially opaque-colored interstitial surface space between them; and
a substantially translucent film sheet that is directly bonded to substantially all of the bottom face of the backing sheet by application of laser energy.

13. The tufted good of claim 12, wherein said film sheet is polyethylene or polypropylene.

14. The tufted good of claim 12, wherein said film sheet and said backing sheet bottom face have the same melting point.

15. The tufted good of claim 12, wherein a continuous superficial layer of substantially all of the backing sheet-adjacent face of said film sheet, but not a substantial portion of the thickness of said film sheet, is deformed by said application of laser energy.

16. The tufted good of claim 15, wherein said applied laser energy is substantially not absorbed by said film sheet, but is substantially absorbed by said backing sheet bottom face, and wherein said bottom face is fused to said film sheet.

17. A tufted good comprising:
a backing sheet having a pile face from which yarn piles project and an opposing bottom face, wherein the bottom face is defined by yarn backloops formed therealong and substantially opaque-colored interstitial surface space between them; and
a substantially translucent film sheet that is directly bonded to substantially all of the bottom face of the backing sheet by simultaneous urging of the film sheet into more intimate contact with the backing sheet and application of laser energy.

18. The tufted good of claim 17, wherein said film sheet and said backing sheet bottom face have the same melting point.

19. The tufted good of claim 17, wherein a continuous superficial layer of substantially all of the backing sheet-adjacent face of said film sheet, but not a substantial portion of the thickness of said film sheet, is deformed by said application of laser energy.

20. The tufted good of claim 17, wherein said applied laser energy is substantially not absorbed by said film sheet, but is substantially absorbed by said backing sheet bottom face, and wherein said bottom face is fused to said film sheet.
